(19) United States
(12) Patent Application Publication
(10) Pub. No.: US 2024/0020378 A1
(43) Pub. Date: Jan. 18, 2024

(54) SECURE JUST-IN-TIME ACCELERATION FRAMEWORK AND METHOD THEREOF

(71) Applicants: Benoit HUDZIA, Belfast (GB); Zanqing ZHANG, Markham (CA)

(72) Inventors: Benoit HUDZIA, Belfast (GB); Zanqing ZHANG, Markham (CA)

(21) Appl. No.: 17/867,115

(22) Filed: Jul. 18, 2022

(51) Int. Cl. G06F 21/53

(52) U.S. Cl. CPC G06F 21/53; G06F 2221/034

(57) ABSTRACT

A computerized method for preparing secure execution of at least a portion of a computer program in a secure execution environment has the steps of identifying at least a portion of source code of the computer program as a trusted-code portion based on one or more annotations of the source code, and converting the trusted-code portion to machine-executable code for execution in the secure execution environment.

### FIELD OF THE DISCLOSURE

The present disclosure relates generally to cloud-computing systems, and in particular to cloud-computing systems using secure just-in-time acceleration framework.

### BACKGROUND

Cloud-computing systems are known. There exist many cloud-computing systems for various data-handling applications such as IBM® Cloud Pak System (IBM is a registered trademark of International Business Machines Corporation of Armonk, New York, USA), Apache® Spark™ (APACHE is a registered trademark of the Apache Software Foundation of Wilmington DELAWARE, USA, and SPARK is a trademark of the Apache Software Foundation CORPORATION of Wilmington DELAWARE, USA), Amazon® Redshift (AMAZON is a registered trademark of Amazon Technologies, Inc. of Seattle WASHINGTON, USA), openLookeng (OLK) of Huawei Technologies Co., Ltd. of Shenzhen, Guangdong, China, and the like.

Cloud-computing systems are often deployed in the so-called public clouds operated by various cloud-computing service providers (also called “multi-tenant infrastructure providers”) for storing and/or processing large datasets, wherein the service thereof are usually accessible to a large number of users. Consequently, private and/or sensitive data may face increased confidentiality and integrity risks.

In recent years, trusted execution environments (TEEs) have caught the attention of scientific and industry communities as they became largely available in user- and server-class machines. TEEs provide security guarantees based on cryptographic constructs' built-in hardware. Since silicon chips are difficult to probe or reverse engineer, they can offer stronger protection against remote or even physical attacks when compared to their software counterparts.

A large code-base consisting of system software on which user applications must trust is therefore not the best approach from a security standpoint. On the other hand, TEEs make it possible for only a small piece of code to be considered safe, that is, belonging to the trusted computing base (TCB). This dramatically reduces the trusted surface, as in this case it suffices to believe that the TEE hardware implementation is correct and has no backdoors, apart from having confidence in the reduced piece of software that runs in isolation, that is, within a protected area (also called an “enclave”).

Traditionally, porting applications to leverage TEE technologies adopt a code-rewrite approach. In this approach, the developers of an application partition its code into trusted code and untrusted code, and completely rewrite the trusted code using TEE API (such as Intel® Software Guard Extensions (Intel® SGX), ARM® TrustZone, and/or the like) for running the trusted code in enclaves. This approach can maintain a minimum TCB and memory footprint because it runs only the rewritten code in enclaves. However, this code-rewrite approach often requires non-trivial efforts from developers, including rewriting all dependent libraries into secure code, which could be tedious and error-prone. Moreover, the rewritten code tends to exhibit deteriorated performance because the code often cannot be specialized with respect to the target hardware at compile time as the target hardware may not be known at the compile time.

### SUMMARY

According to one aspect of this disclosure, there is provided a computerized method comprising: identifying at least a portion of source code of a computer program as a trusted-code portion based on one or more annotations of the source code; and converting the trusted-code portion to machine-executable code for execution in a secure execution environment.

In some embodiments, the method further comprises: storing the machine-executable code of the trusted-code portion in the secure execution environment.

In some embodiments, the method further comprises at least one of: encrypting the machine-executable code; and signing the machine-executable code.

In some embodiments, said converting the trusted-code portion to the machine-executable code comprises: adding one or more proxy functions to the machine-executable code for processing function calls initiated from outside of the secure execution environment.

In some embodiments, said converting the trusted-code portion to the machine-executable code comprises: converting the trusted-code portion to an intermediate representation (IR) as the machine-executable code for execution by a virtual machine.

In some embodiments, said converting the trusted-code portion to the machine-executable code comprises: converting the trusted-code portion to an intermediate representation (IR); and converting the IR at runtime to the machine-executable code for execution.

In some embodiments, said converting the IR at the runtime to the machine-executable code comprises: optimizing the IR at the runtime using information obtained at the runtime.

In some embodiments, said information obtained at the runtime comprises runtime and hardware information.

In some embodiments, the method further comprises: validating and auditing the machine-executable code of the trusted-code portion; and executing the machine-executable code of the trusted-code portion in the secure execution environment.

In some embodiments, the method further comprises: receiving a function-call to a function of the machine-executable code of the trusted-code portion; validating and auditing the received function-call; and executing the function of the machine-executable code of the trusted-code portion if the received function-call is validated and audited.

According to one aspect of this disclosure, there is provided a computer system comprising a processor for: identifying at least a portion of source code of a computer program as a trusted-code portion based on one or more annotations of the source code; and converting the trusted-code portion to machine-executable code for execution in a secure execution environment.

According to one aspect of this disclosure, there is provided one or more non-transitory computer-readable storage devices comprising computer-executable instructions, wherein the instructions, when executed, cause a processor to perform actions comprising: identifying at least a portion of source code of a computer program as a trusted-code portion based on one or more annotations of the source code; and converting the trusted-code portion to machine-executable code for execution in a secure execution environment.

In some embodiments, the instructions, when executed, cause the processor to perform further actions comprising: storing the machine-executable code of the trusted-code portion in the secure execution environment.

In some embodiments, the instructions, when executed, cause the processor to perform further actions comprising at least one of: encrypting the machine-executable code; and signing the machine-executable code.

In some embodiments, said converting the trusted-code portion to the machine-executable code comprises: adding one or more proxy functions to the machine-executable code for processing function calls initiated from outside of the secure execution environment.

In some embodiments, said converting the trusted-code portion to the machine-executable code comprises: converting the trusted-code portion to an intermediate representation (IR) as the machine-executable code for execution by a virtual machine.

In some embodiments, said converting the trusted-code portion to the machine-executable code comprises: converting the trusted-code portion to an intermediate representation (IR); and converting the IR at runtime to the machine-executable code for execution.

In some embodiments, said converting the IR at the runtime to the machine-executable code comprises: optimizing the IR at the runtime using information obtained at the runtime.

In some embodiments, said information obtained at the runtime comprises runtime and hardware information.

In some embodiments, said converting the trusted-code portion to the machine-executable code comprises: validating and auditing the machine-executable code of the trusted-code portion; and executing the machine-executable code of the trusted-code portion in the secure execution environment.

In some embodiments, said converting the trusted-code portion to the machine-executable code comprises: receiving a function-call to a function of the machine-executable code of the trusted-code portion; validating and auditing the received function-call; and executing the function of the machine-executable code of the trusted-code portion if the received function-call is validated and audited.

By using the method, system, and computer-readable storage devices disclosed herein, an application developer only requires to annotate the source code to indicate the trusted-code portions which will be executed in an secure environment such as an enclave, and untrusted-code portions which does not need to be executed in the secure environment (that is, it may or may not be executed in the secure environment depending on the implementation). Based on the annotation, a compiling tool converts the trusted-code portions into secure executable for storing and executing in the secure environment with enhanced security and authentication measurements.

Thus, the method, system, and computer-readable storage devices disclosed herein retain the execution of the executable of the trusted-code portions by leveraging unmodified, normal secure-environment execution process, thereby providing secure just-in-time (JIT) processes with end-to-end auditable tooling, process, and execution environment. In some embodiments, the method, system, and computer-readable storage devices disclosed herein provide support for dynamic secure code injection (for example, user-defined functions) without restarting the runtime environment.

In some embodiments, the method, system, and computer-readable storage devices disclosed herein use JIT compilation and runtime optimization to optimize the executable of the trusted-code portions in runtime within the secure execution environment. The runtime optimization leverages runtime specifics and hardware information to generate secure computation functions/kernel for improving the performance of the secure enclave processes.

In some embodiments, the method, system, and computer-readable storage devices disclosed herein provides automatic proxy functions for interfacing between the secure executable and unsecure executable. The use of proxy functions allows safe interfacing between the secure executable and unsecure executable. Moreover, the use of proxy functions allows secure third-party IR registration.

With above-described features and other features disclosed herein, the method, system, and computer-readable storage devices disclosed herein enable trusted execution environment (TEE) with improved performance and ease of portability for efficiently protecting applications.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of the present disclosure;

FIG. 2 is a schematic diagram showing a simplified hardware structure of a computing device of the computer network system shown in FIG. 1;

FIG. 3 a schematic diagram showing a simplified software architecture of a computing device of the computer network system shown in FIG. 1;

FIG. 4 is a block diagram showing a secure just-in-time (JIT) acceleration framework of the computer network system shown in FIG. 1, according to some embodiments of the present disclosure;

FIG. 5 is a block diagram showing a secure JIT acceleration framework of the computer network system shown in FIG. 1, according to some other embodiments of the present disclosure;

FIG. 6A is a block diagram showing an ahead-of-time (AOT) stage of a secure JIT acceleration framework of the computer network system shown in FIG. 1, according to yet some other embodiments of the present disclosure;

FIG. 6B is a block diagram showing the detail of function calls from the executable of untrusted-code portions to the executable of trusted-code portions of a program in a secure JIT acceleration framework of the computer network system shown in FIG. 1, according to yet some other embodiments of the present disclosure; and

FIG. 7 is a block diagram showing an example of using the computer network system shown in FIG. 1 with a secure JIT acceleration framework for data processing.

### DETAILED DESCRIPTION

A. System Structure

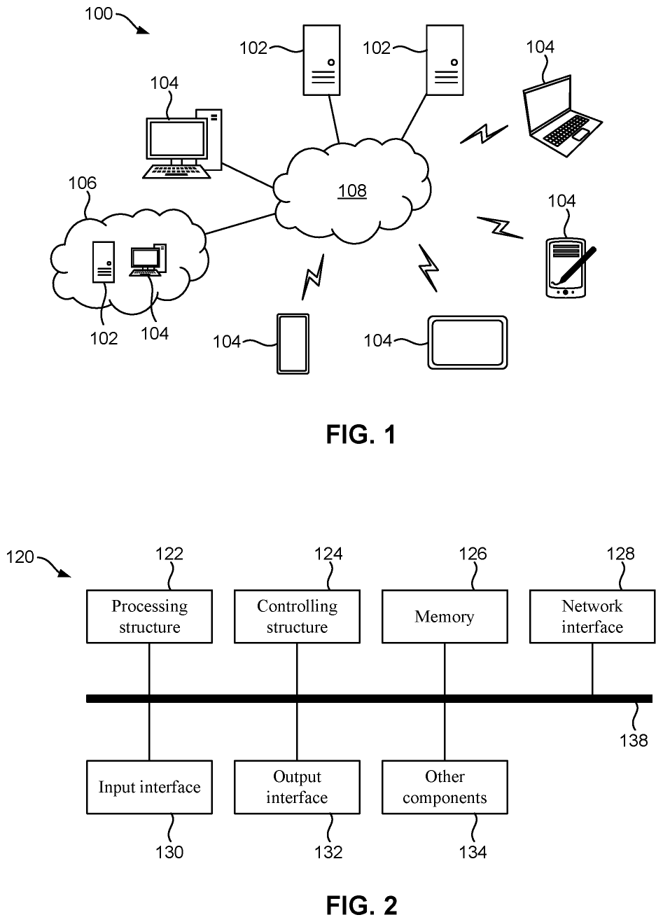

Turning now to FIG. 1, a computer network system is shown and is generally identified using reference numeral 100. In these embodiments, the computer network system 100 is a so-called cloud-computing system or platform for providing various data services to a plurality of users.

As shown in FIG. 1, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure 120 shown in FIG. 2. As shown, the hardware structure 120 comprises a processing structure 122, a controlling structure 124, one or more non-transitory computer-readable memory or storage devices 126, a network interface 128, an input interface 130, and an output interface 132, functionally interconnected by a system bus 138. The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD ° microprocessors (AMD is a registered trademark of Advanced Micro Devices Inc., Sunnyvale, CA, USA), ARM ° microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing an encryption process and/or a decryption process, as the design purpose and/or the use case may be, for encrypting and/or decrypting data received from the input 106 and outputting the resulting encrypted or decrypted data through the output 108.

For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 1, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH ° (BLUETOOTH is a registered trademark of Bluetooth Sig Inc., Kirkland, WA, USA), Bluetooth Low Energy (BLE), Z-Wave, Long Range (LoRa), ZIGBEE ° (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

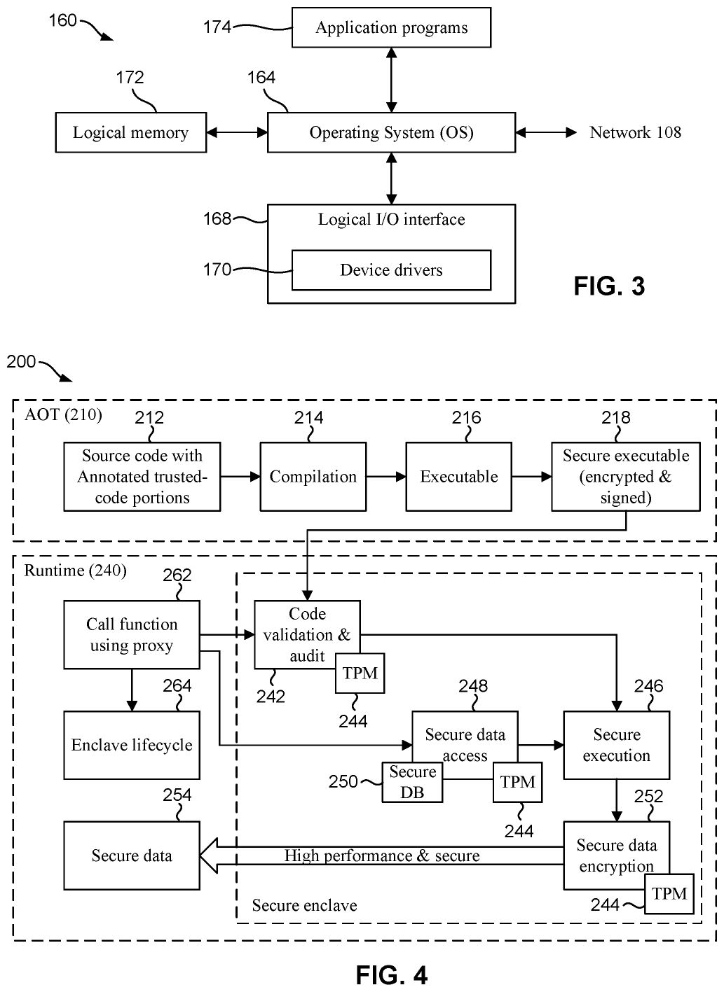

FIG. 3 shows a simplified software architecture 160 of the computing device 102 or 104. The software architecture 160 comprises an operating system 164, a logical input/output (I/O) interface 168, a logical memory 172, and one or more programs 174 (collectively denoted “application programs” to differentiate from the programs of the operation system 164). The operating system 164, logical I/O interface 168, and one or more application programs 174 are generally implemented as computer-executable instructions or code in the form of software programs or firmware programs stored in the logical memory 172 which may be executed by the processing structure 122.

The operating system 164 manages various hardware components of the computing device 102 or 104 via the logical I/O interface 168, manages the logical memory 172, and manages and supports the application programs 174. The operating system 164 is also in communication with other computing devices (not shown) via the network 108 to allow application programs 174 to communicate with those running on other computing devices. As those skilled in the art will appreciate, the operating system 164 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Unix, Linux, ANDROID® (ANDROID is a registered trademark of Google LLC, Mountain View, CA, USA), or the like. The computing devices 102 and 104 of the computer network system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

The one or more application programs 174 executed by or run by the processing structure 122 for performing various tasks. In a server computer 102, the one or more application programs 174 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 disclosed herein and the modules, circuitries, and components thereof, as a combination of hardware and software, generally produces tangible results tied to the physical world, wherein the tangible results such as those disclosed herein may lead to improvements to the computer devices and systems themselves, the modules, circuitries, and components thereof, and/or the like.

In fact, with the advance of computer technologies, the boundary between hardware and software is fading. For example, an application may appear to the users that it is executed in one logic server (also called a “virtual server”) while different application programs or program modules of the application may be executed on a plurality of server computers and/or with the use of resources from a plurality of server computers and/or a plurality of network components. Such a computer network system is also denoted a distributed system.

Moreover, while the software structure 160 shown in FIG. 3 partitions the programs running on a computing device 102/104 as an OS 164 and application programs 174, those skilled in the art will appreciate that such a program-partitioning may vary in different embodiments. For example, a program such as a compiler (which translates human-readable source code into target code for execution by a computing device 102/104) may be implemented as an application program 174 in some embodiments, and may be implemented as a part of the OS 164 in some other embodiments.

B. Trusted Execution Environments

As described above, a computer network system 100 such as a cloud computing system accessible to a large number of users often faces significant confidentiality and integrity risks. Thus, many cloud computing systems use trusted execution environments (TEEs) to provide security guarantees based on cryptographic constructs' built-in hardware.

By using TEEs, some pieces of code may be stored and run in protected areas such as so-called “enclaves”, secured and protected by the TEE hardware implementation. Such pieces of code form the trusted computing base (TCB) providing confidentiality and integrity.

More specifically, a data enclave is a secure network through which confidential data may be stored and disseminated (see https://nnlm.gov/guides/data-thesaurus/data-enclave), thereby providing many advantages. For example, secure enclaves may be used for outsourcing data analysis, which is often distributed for large datasets or complicated analyses.

There are several tools that port entire existing applications into an enclave which, however, is not always preferable because many applications are not hardened for side-channel attacks. Moreover, placing an entire application within the enclave results in an unnecessarily large TCB.

In distributed applications, program code that affects data flow but not the data content may be placed outside of the enclave thereby reducing the TCB as only security-sensitive code needs to be placed within the enclave while all other code may be placed outside thereof. However, as described above, rewriting the trusted code of an application using TEE API (such as Intel® Software Guard Extensions (Intel® SGX), ARM® TrustZone, and/or the like) for running the trusted code in enclaves may be tedious and lead to lowered performance.

As those skilled in the art readily understand, the rewritten trusted code is generally human-readable source code which needs to be translated into machine-executable code (also simply denoted “executable”) for execution.

In existing systems, the rewritten trusted code (that is, the source code) needs to be pre-compiled for each specific environment and data set to obtain respective target code prior to execution, which may be a viable option only when the benefit of pre-compiling outweighs the overhead. Only a few use cases with extremely long-lived secure computations (which require hours or more computation time) can benefit from this approach. Moreover, such pre-compiling may require the developer to manually modify the source code to match the target environment and operations.

Thus, the existing trusted-code/untrusted-code partitioning solutions are not targeted for distributed applications, and they would not optimally partition the code for distributed applications. Moreover, the overall process of creating secure code and enclaves is difficult, error-prone, and lacking flexibility for large-scale and compute-intensive operation viability.

In the following, various embodiments of computer network systems and methods are described for providing a secure just-in-time (JIT) acceleration framework for implementing secure, distributed systems using TEE and solving at least some of the following disadvantage of existing systems:
Secure enclave requires pre-signed and pre-compiled code for guaranteeing secure and auditable operations, which implies that the resulting binary needs to be statically compiled prior to deployment, thereby limiting customization for each customer environment.
Pre-compiled code cannot be pre-optimized to leverage specific hardware architecture. For example, ARM® and Intel® x64 architectures have different acceleration mechanisms which vary between process generation. Pre-compilation prevents the code from leveraging a customer-specific hardware environment and greatly limits the performance of the system.
Pre-compiled code cannot be dynamically optimized based on the data and operations at runtime. Similar to above-described dissimilarity of different hardware environments, the data to be processed by the code may vary greatly. One of the techniques for optimizing operations of heterogeneous data requires data introspection and subsequent code optimization, which cannot be done with the existing enclave life-cycle model, thereby further limiting the performance of the system.

As will be described in more detail below, in various embodiments, the computer network system 100 uses a secure JIT acceleration framework for facilitating the partition of application code into trusted and untrusted code in order to reduce the TCB. All code that may access sensitive data or affect data flow is considered trusted code and placed into the enclave.

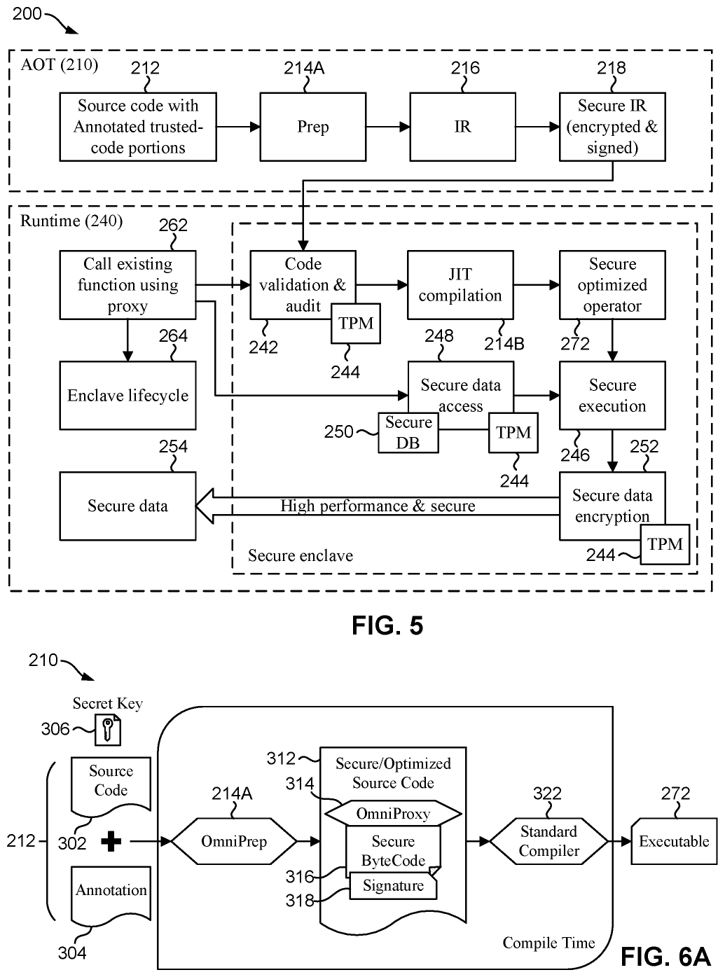

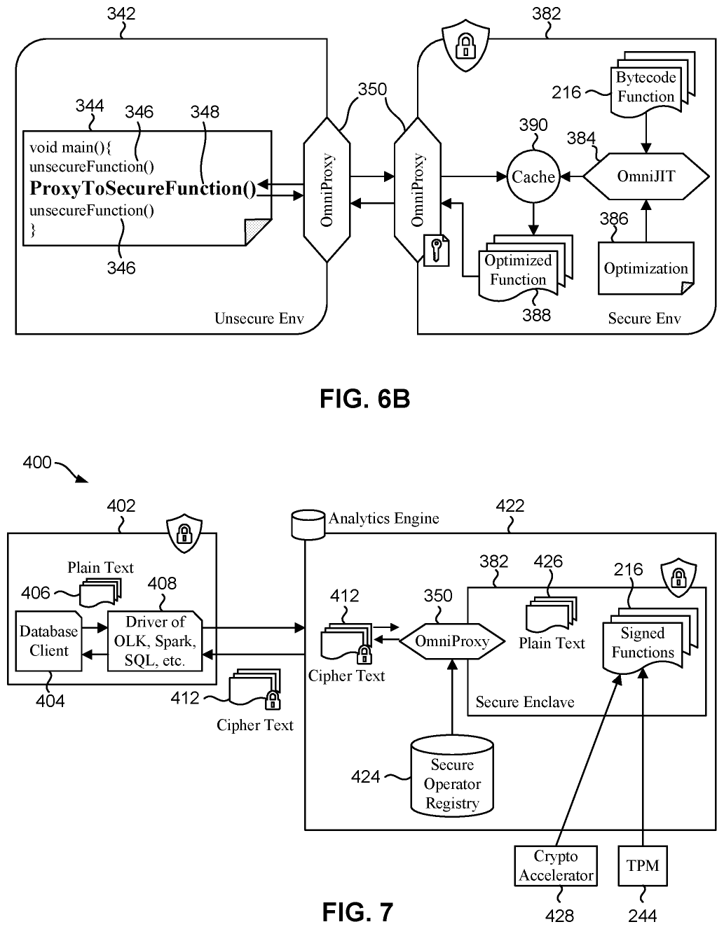

FIG. 4 is a schematic diagram showing the secure JIT acceleration framework 200. For simplicity, FIG. 4 (as well as FIGS. 5 and 6A) mainly shows the processing of the portions of trusted code (described in more detail later). As shown, the secure JIT acceleration framework 200 comprises a compile-time tool using for annotating, transforming, and generating secure code execution at an ahead-of-time (AOT) stage 210, and a runtime environment for executing the compiled code at a runtime stage 240.

Before the AOT stage 210, an application developer such as a programmer may annotate the source code of an application program 174 to obtain annotated source code wherein the annotation indicates the portions of trusted code (denoted the “trusted-code portions” hereinafter) for storing and execution in the secure enclave. Such annotation generally does not modify the functionalities of the trusted-code portions and may be in any suitable form such as source-code comments (wherein the developer may use, for example, plain language and/or predefined keywords to indicate that the portion is a trusted code), tags, properties associated with the trusted-code portions, and/or the like. Thus, the annotation identifies which functions or trusted-code portions may be specially treated (described in more detail later) when being compiled or otherwise converted to machine-executable code (also simply denoted “executable”) and when the corresponding executable is executed. In various embodiments, the machine-executable code may be machine code directly executable by a physical processing structure 122 and/or intermediate code (such as an intermediate representation (IR), for example, in the form of bytecode) executable by a virtual machine (for example, via an interpreter thereof).

In these embodiments, the portions that are not indicated as trusted code are portions of untrusted code (denoted the “untrusted-code portions” hereinafter) and may be stored and executed outside the secure enclave.

At the AOT stage 210, the compile-time tool parses the annotated source code 212 and generates machine-executable code 216 (step 214). The machine-executable code 216 comprises an unsecure executable (not shown) converted from and representing the untrusted-code portions and a secure executable 218 converted from and representing the trusted-code portions. When converting the trusted-code portions to the secure executable 218, the compile-time tool adds one or more proxy functions to the secure executable 218. As will be described below, the one or more proxy functions act as the interface for processing function-calls initiated from unsecure programs (which may be the executables or other executables such as third-party programs executed outside the enclave) for and executing the called functions of the secure executable 218 on behalf of the unsecure programs.

In some embodiments, the secure executable 218 may be encrypted (for security) and signed (for authentication), and then stored in the enclave.

The executable 216 of the application program 174 may be executed through the runtime environment execution process 240. As shown in FIG. 4, the secure executable 218 is first loaded from the memory of the enclave, decrypted, and then validated and audited by a code validation and audit module 242 which may be hardware-protected by a hardware-based security chip 244 such as a trusted platform module (TPM). The successfully validated and audited secure executable 218 is then securely executed in the enclave (step 246).

During the secure execution, the secure executable 218 may access secure data from a secure data source 250 such as a secure database via a secure data access module 248 which may be hardware-protected by a hardware-based security chip 244 such as the TPM. The data generated by the secure executable 218 may be encrypted by a secure data encryption module 252 which may be hardware-protected by a hardware-based security chip 244 such as the TPM. The encrypted data 254 may be output to a target (such as a client-computing device 104) in a manner with high performance and security.

As described above, the executable 216 of the application program 174 may also comprise an unsecure executable which may be executed outside the enclave. When the unsecure executable calls a function of the secure executable 218, the unsecure executable calls a function of the secure executable 218 via a proxy function (step 262) for achieving security, authentication, and verifiable enclave lifecycle 264. The proxy passes the function call to the code validation and audit module 242 for validation and audit. After successfully validating and auditing the function call, the called function of the secure executable 218 is securely executed in the enclave (step 246).

The function call from the unsecure executable may also need to access secure data from the secure data source 250. Similar to the description above, such a secure data access is performed via the secure data access module 248.

As described above, the machine-executable code generated and executed by the secure JIT acceleration framework 200 may be machine code and/or an IR. FIG. 5 shows an example of the secure JIT acceleration framework 200 generating an IR 216 at AOT and compiling the IR at runtime for execution, according to some embodiments of this disclosure.

The secure JIT acceleration framework 200 in these embodiments is similar to that shown in FIG. 4 except that the compilation in these embodiments comprise a preprocessing step 214A for generating an IR from the annotated source code and a JIT compilation step 214B for obtaining runtime-compiled machine-executable code (which may be machine code or bytecode).

As shown in FIG. 5, before the AOT stage 210, an application developer may annotate the source code of an application program 174 to obtain the annotated source code. The annotated source code portions are the trusted-code portions and the unannotated portions are untrusted-code portions.

At the preprocessing step 214A, the compile-time tool or a preprocessor thereof parses the annotated source code and generates an optimized IR 216. As those skilled in the art understand, the IR is the data structure or code converted from the source code and used by a compiler for further processing (such as compiling to machine code) or used by a virtual machine for execution.

The IR 216 comprises an unsecure IR (not shown) converted from and representing the untrusted-code portions and an optimized, secure IR 218 converted from and representing the trusted-code portions. In some embodiments, the secure IR 218 is encrypted (for security) and signed (for authentication), and then stored in the enclave.

The IR 216 of the application program 174 may be executed through the runtime environment execution process 240. As shown in FIG. 5, the secure IR 218 is first loaded from the memory of the enclave, decrypted, and then validated and audited by a code validation and audit module 242 which may be hardware-protected by a hardware-based security chip 244 such as a TPM. The successfully validated and audited secure IR 218 is then compiled and optimized in runtime (step 214B) by a JIT compilation module using the runtime and hardware information, to obtain secure runtime-compiled machine-executable code 272 which comprises one or more secure optimized operators that may be dynamically invoked by the proxy functions (for example, a proxy function may invoke a secure function which in turn invokes the optimized operator). The runtime-compiled machine-executable code may be saved in a cache for further reuse if needed.

As those skilled in the art will appreciate, while certain parameters used by the application program 174, such as loop trip counts, values read from configuration files, user-input, and/or the like, may affect the performance thereof, the values thereof may only be known at runtime. Thus, in some embodiments, context information comprising the values of such parameters may be passed to the JIT compilation module to allow JIT-compilation of some functions and specializing such parameters in runtime at step 214B for specializing and further optimizing the runtime-compiled machine-executable code for improved performance. Moreover, in some embodiments, the context information provided in runtime at step 214B may further comprise information of specific hardware functionalities (such as some features of CPU, FPGA, GPU, DPU, and/or the like) that is unknown at the AOT stage 210 for specializing and further optimizing the runtime-compiled machine-executable code for improved performance.

The secure runtime-compiled machine-executable code 272 is securely executed by a virtual machine in the enclave (step 246). During the secure execution, the secure runtime-compiled machine-executable code 272 may access secure data from a secure data source 250 such as a secure database via a secure data access module 248 which may be hardware-protected by a hardware-based security chip 244 such as the TPM. The data generated by the secure runtime-compiled machine-executable code may be encrypted by a secure data encryption module 252 which may be hardware-protected by a hardware-based security chip 244 such as the TPM. The encrypted data 254 may be output to a target (such as a client-computing device 104) in a manner with high performance and security.

In various embodiments, the unsecure IR may be executed by a virtual machine outside the enclave or may be compiled in runtime by a runtime compiler and then executed by a virtual machine or a physical processor. When the unsecure IR (or the runtime-compiled machine-executable code thereof) calls a function of the secure runtime-compiled machine-executable code, the unsecure IR calls a function of the secure runtime-compiled machine-executable code via a proxy (step 262) for achieving security, authentication, and verifiable enclave lifecycle 264. The proxy passes the function call to the code validation and audit module 242 for validation and audit. After successfully validating and auditing the function call, the called function of the secure runtime-compiled machine-executable code is securely executed in the enclave (step 246).

In some embodiments, the secure JIT acceleration framework 200 may be use for data analysis (such as the so-called big data analysis) using various databases and queries for translating or otherwise converting database queries to secure and optimized machine-executable code. Details and examples of such a data-analysis system may be found in PCT Patent Application Ser. No. PCT/CN2021/103461, the content of which is incorporated herein by reference in its entirety. For example, in some embodiments, the secure JIT acceleration framework 200 uses OmniRuntime which is a generic data analytics accelerator for analytics platforms such as openLooKeng, Apache Spark, Apache Hive, and the like, and provides cross-platform capabilities with support of various processors such as ARM® microprocessors, Intel® microprocessors, GPUs, FPGAs, data processing units (DPUs), and the like. In these embodiments, the source code may be, for example, C++ source code, the preprocessor may be the OmniPrep module of OmniRuntime, the function-call proxy (used at step 262) may the OmniProxy of OmniRuntime, and the JIT compilation module (used at step 214B) may be the OmniJIT module of OmniRuntime. Moreover, the IR 216 may be an OmniIR and the secure IR 218 may comprise SecureOmniJit proxy functions with embedded, signed bytecode.

FIG. 6A shows the AOT stage 210 of the secure JIT acceleration framework 200 according to some embodiments of this disclosure. As shown, the annotated source code 212 comprises the source code 302 and the developer's annotation 304 for indicating trusted-code portions. The preprocessor (such as the OmniPrep) of the compile-time tool parses the annotated source code 212 and generate a secure optimized intermediate code 312 which comprises the unmodified untrusted-code portions (not shown), the SecureOmniJit proxy functions 314 with embedded bytecode 316 converted from the trusted-code portions. In these embodiments, the secure optimized intermediate code 312 may be encrypted and authenticated using a secret key 306 and a signature 318.

The secure optimized intermediate code 312 is then compiled using a compiler environment 322 (which may be, for example, any standard or conventional compiler the developer chooses to use) to obtain the executable 272. The obtained executable 272 comprises the executable of the SecureOmniJit proxy functions 314 for enclave establishment, and signed bytecode 316 (corresponding to the trusted-code portions) for secure execution.

As those skilled in the art will appreciate, the compiler environment 322 may comprise an AOT-stage compiler used at the AOT stage 210 for obtaining the executable 272. Alternatively, the compiler environment 322 may comprise an AOT-stage compiler for obtaining an IR and a runtime compiler for converting the IR to the executable 272 at runtime.

In these embodiments, the executables of the untrusted-code portions and the trusted-code portions are generally in the same binary file or the same package (forming the executable 272) and may be stored together in a secured storage. Moreover, the executables of the untrusted-code portions and the trusted-code portions may both be encrypted for security and authentication purposes.

In some alternative embodiments, the executable 272 comprises separate binary files or packages for executables of the untrusted-code portions and the trusted-code portions. The binary file or package of the untrusted-code portions comprises the executable of the untrusted-code portions, and the SecureOmniJit proxy functions 314. The binary file or package of the trusted-code portions comprises the signed bytecode 316 and the signature 318. Thus, the executable 272 in these embodiments is suitable for secure distributed execution and may be suitable for Internet-of-Things (IoT) edge (wherein IoT devices communicate real-time data to a network) and third-party processing scenarios (such as Federated machine learning (ML) wherein machine learning models are trained using data sets located in different sites without sharing the data sets located between the different sites).

This obtained executable 272 may then be executed at runtime in a manner as described above (FIG. 4 or FIG. 5), wherein the executable of the trusted-code portions requires code validation and audit 242 prior to its execution and function-calls initiated from the executable of the untrusted-code portions to the signed bytecode 316 are performed through the SecureOmniJit proxy functions 314 and with code validation and audit 242 prior to execution of the called functions. FIG. 6B shows the detail of function calls from the executable of the untrusted-code portions to the executable of the trusted-code portions.

As shown, the executable 344 of the untrusted-code portions in the unsecure environment 342 comprises one or more unsecure functions 346 and one or more proxy functions 348 (denoted “ProxyToSecureFunction” in FIG. 6B). As described above, the executable 216 of the trusted-code portions in the secure environment 382 such as the enclave are optimized 286 by the OmniJIT module 384 and the optimized executable or functions 388 are stored in a cache 390 in the secure environment 382.

When the executable 344 of the untrusted-code portions in the unsecure environment 342 calls a function of the executable 216 of the trusted-code portions in the secure environment 382, the executable 344 uses the ProxyToSecureFunction 348 to pass the function-call to the secure environment 382 via the function-call proxy 350 such as the OmniProxy. After validating and auditing the received function-call, the secure environment 382 then passes the function-call to the corresponding function 388 of the executable 216 in the cache 390. The called function 388 is then executed in the secure environment 382 and returns the execution results to the executable 344 via the OmniProxy 350.

Those skilled in the art will appreciate that the secure JIT acceleration framework 200 disclosed herein provides a method for annotating, transforming, and generating secure code execution, thereby allowing to achieve security assurance without the need to explicitly re-code or modify the original source code.

By using the secure JIT acceleration framework 200 disclosed herein, an application developer only requires to annotate the source code to indicate the trusted-code portions which will be executed in an secure environment such as an enclave, and untrusted-code portions which does not need to be executed in the secure environment (that is, it may or may not be executed in the secure environment depending on the implementation). In above embodiments, the developer may annotate the trusted-code portions and the unannotated code portions are considered the untrusted-code portions. In some other embodiments, the developer may annotate the untrusted-code portions and the unannotated code portions are considered the trusted-code portions. One advantage of the annotation method disclosed herein is that the source code does not need to be modified for execution in the secure environment, thereby providing a low to no-code approach for implement TEE systems.

Based on the annotation, an AOT compiling tool converts the trusted-code portions into secure executable for storing and executing in the secure environment with enhanced security and authentication measurements. The AOT compiling tool also convert the untrusted-code portions into unsecure or regular executable such that it may be stored and/or executed in unsecure or regular environment without the enhanced security and authentication measurements. Of course, if needed, the regular executable may also be stored and/or executed in secure environment with enhanced security and authentication measurements.

Thus, the secure JIT acceleration framework 200 disclosed herein retains the execution of the executable of the trusted-code portions by leveraging unmodified, normal secure-environment execution process. The executable of the trusted-code portions is signed and validated prior to execution, thereby providing secure JIT processes with end-to-end auditable tooling, process, and execution environment. Moreover, the secure JIT acceleration framework 200 disclosed herein provides support for dynamic secure code injection (for example, user-defined functions) without restarting the runtime environment.

In some embodiments, the secure JIT acceleration framework 200 disclosed herein uses JIT compilation and runtime optimization to optimize the executable of the trusted-code portions in runtime within the secure execution environment. The runtime optimization leverages runtime specifics and hardware information to generate secure computation functions/kernel for improving the performance of the secure enclave processes.

In some embodiments, the secure JIT acceleration framework 200 disclosed herein allows secure dynamic execution of the trusted-code portions in distributed systems while leveraging JIT compilation for optimizing the machine code for the hardware of the enclave, thereby eliminating significant overhead introduced by the encrypted memory environment.

In some embodiments, the secure JIT acceleration framework 200 disclosed herein provides automatic proxy functions for interfacing between the secure executable and unsecure executable. In the secure executable, the IR and proxy functions are encrypted and signed.

The use of proxy functions allows safe interfacing between the secure executable and unsecure executable. Moreover, the use of proxy functions allows secure third-party IR registration.

In some embodiments, the secure JIT acceleration framework 200 disclosed herein provides a natural integration with the C++ language while making secure enclave with JIT easy to use. A developer may enable SecureJlT-compilation support by simply using the pre-processor tools to transform the original source code to inject proxy functions by simply annotating the functions to be run in the secure enclave using a simple macro preprocessing annotation.

The secure JIT acceleration framework 200 disclosed herein also provides enclave life-cycle management.

With above-described features, the secure JIT acceleration framework 200 disclosed herein enables TEE systems with improved performance and ease of portability for efficiently protecting applications.

The secure JIT acceleration framework 200 disclosed herein may be used in various areas. FIG. 7 shows an example of using the secure JIT acceleration framework 200 disclosed herein for big-data processing.

As shown, a data processing system 400 with TEE is implemented using the secure JIT acceleration framework 200 disclosed herein. The data processing system 400 comprises a front module 402 and an analytics engine 422, both with suitable security implementations. The front module 402 receives plain-text inquiries 406 from a database client 404 and uses a suitable database driver 408 such as an OLK driver, a Spark driver, a SQL driver, or the like, to parse the plain-text inquiries 406, encrypt the parsed inquiries, and send the encrypted parsed inquiries to the analytics engine 422 as cipher text 412.

The analytics engine 422 passes the received cipher text 412 to the secure environment 382 such as the enclave via the function-call proxy 350 such as the OmniProxy (with the support of a secure operator registry 424). In the secure environment 382, the authentication of the cipher text 412 is verified and then the cipher text 412 is decrypted to plain text 426 of the parsed inquiries. Functions of the signed executable 216 of the trusted-code portions are then executed with support of suitable hardware components such as the cryptographic accelerator 428, the TPM 244, and/or the like, to process the parsed inquiries to obtain the analytical results, encrypt the obtained analytical results, and then send the encrypted analytical results to the front module 402 via the OmniProxy 350.

The secure JIT acceleration framework 200 disclosed herein may be used in other areas such as telecommunication systems at the edge of a telecommunication network for secure deployment of network function at the edge, multi-party computation for allowing confidential and trusted computation within a quorum of untrusted parties and infrastructure, and the like.

### REFERENCES

[1] Wenting Zheng, Ankur Dave, Jethro G. Beekman, Raluca Ada Popa, Joseph E. Gonzalez, and Ion Stoica, “Opaque: An Oblivious and Encrypted Distributed Analytics Platform,” 14th USENIX Symposium on Networked Systems Design and Implementation (NSDI 17), Boston, MA, published by USENIX Association, March 2017, pages 283-298.
[2] Felix Schuster, Manuel Costa, Cedric Fournet, Christos Gkantsidis, Marcus Peinado, Gloria Mainar-Ruiz, and Mark Russinovich, “VC3: Trustworthy Data Analytics in the Cloud using SGX,” 2015 IEEE Symposium on Security and Privacy, San Jose, CA, USA, May 17-21, 2015, pages 38-54.
[3] Jianyu Jiang, Xusheng Chen, TszOn Li, Cheng Wang, Tianxiang Shen, Shixiong Zhao, Heming Cui, Cho-Li Wang, and Fengwei Zhang, “Uranus: Simple, Efficient SGX Programming and its Applications,” Proceedings of the 15th ACM Asia Conference on Computer and Communications Security, October 2020, pages 826-840.

Although embodiments have been described above with reference to the accompanying drawings, those of skill in the art will appreciate that variations and modifications may be made without departing from the scope thereof as defined by the appended claims.

What is claimed is:

1. A computerized method comprising:
identifying at least a portion of source code of a computer program as a trusted-code portion based on one or more annotations of the source code; and
converting the trusted-code portion to machine-executable code for execution in a secure execution environment.

2. The method of claim 1 further comprising:
storing the machine-executable code of the trusted-code portion in the secure execution environment.

3. The method of claim 1 further comprising at least one of:
encrypting the machine-executable code; and
signing the machine-executable code.

4. The method of claim 1, wherein said converting the trusted-code portion to the machine-executable code comprises:
adding one or more proxy functions to the machine-executable code for processing function calls initiated from outside of the secure execution environment.

5. The method of claim 1, wherein said converting the trusted-code portion to the machine-executable code comprises:
converting the trusted-code portion to an intermediate representation (IR) as the machine-executable code for execution by a virtual machine.

6. The method of claim 1, wherein said converting the trusted-code portion to the machine-executable code comprises:
converting the trusted-code portion to an intermediate representation (IR); and
converting the IR at runtime to the machine-executable code for execution.

7. The method of claim 6, wherein said converting the IR at the runtime to the machine-executable code comprises:
optimizing the IR at the runtime using information obtained at the runtime.

8. The method of claim 7, wherein said information obtained at the runtime comprises runtime and hardware information.

9. The method of claim 1 further comprising:
validating and auditing the machine-executable code of the trusted-code portion; and
executing the machine-executable code of the trusted-code portion in the secure execution environment.

10. The method of claim 1 further comprising:
receiving a function-call to a function of the machine-executable code of the trusted-code portion;
validating and auditing the received function-call; and
executing the function of the machine-executable code of the trusted-code portion if the received function-call is validated and audited.

11. A computer system comprising a processor for:
identifying at least a portion of source code of a computer program as a trusted-code portion based on one or more annotations of the source code; and
converting the trusted-code portion to machine-executable code for execution in a secure execution environment.

12. One or more non-transitory computer-readable storage devices comprising computer-executable instructions, wherein the instructions, when executed, cause a processor to perform actions comprising:
identifying at least a portion of source code of a computer program as a trusted-code portion based on one or more annotations of the source code; and
converting the trusted-code portion to machine-executable code for execution in a secure execution environment.

13. The one or more non-transitory computer-readable storage devices according to claim 12, wherein the instructions, when executed, cause the processor to perform further actions comprising:
storing the machine-executable code of the trusted-code portion in the secure execution environment.

14. The one or more non-transitory computer-readable storage devices according to claim 12, wherein the instructions, when executed, cause the processor to perform further actions comprising at least one of:
encrypting the machine-executable code; and
signing the machine-executable code.

15. The one or more non-transitory computer-readable storage devices according to claim 12, wherein said converting the trusted-code portion to the machine-executable code comprises:
adding one or more proxy functions to the machine-executable code for processing function calls initiated from outside of the secure execution environment.

16. The one or more non-transitory computer-readable storage devices according to claim 12, wherein said converting the trusted-code portion to the machine-executable code comprises:
converting the trusted-code portion to an intermediate representation (IR) as the machine-executable code for execution by a virtual machine.

17. The one or more non-transitory computer-readable storage devices according to claim 12, wherein said converting the trusted-code portion to the machine-executable code comprises:
converting the trusted-code portion to an intermediate representation (IR); and
converting the IR at runtime to the machine-executable code for execution.

18. The one or more non-transitory computer-readable storage devices according to claim 17, wherein said converting the IR at the runtime to the machine-executable code comprises:
optimizing the IR at the runtime using information obtained at the runtime.

19. The one or more non-transitory computer-readable storage devices according to claim 18, wherein said information obtained at the runtime comprises runtime and hardware information.

20. The one or more non-transitory computer-readable storage devices according to claim 12, wherein said converting the trusted-code portion to the machine-executable code comprises:
validating and auditing the machine-executable code of the trusted-code portion; and
executing the machine-executable code of the trusted-code portion in the secure execution environment.

21. The one or more non-transitory computer-readable storage devices according to claim 12, wherein said converting the trusted-code portion to the machine-executable code comprises:
receiving a function-call to a function of the machine-executable code of the trusted-code portion;
validating and auditing the received function-call; and
executing the function of the machine-executable code of the trusted-code portion if the received function-call is validated and audited.
